(19) United States
(12) Patent Application Publication
(10) Pub. No.: US 2011/0104036 A1
(43) Pub. Date: May 5, 2011

(54) METHOD AND APPARATUS FOR PURIFYING METALLURGICAL GRADE SILICON BY DIRECTIONAL SOLIDIFICATION AND FOR OBTAINING SILICON INGOTS FOR PHOTOVOLTAIC USE

(75) Inventor: Sergio Pizzini, Sesto Calende (IT)

(73) Assignee: N.E.D. SILICON S.P.A., OSIMO (IT)

(21) Appl. No.: 12/999,511

(22) PCT Filed: May 27, 2009
(86) PCT No.: PCT/EP09/56482

§ 371 Date: Dec. 16, 2010

(30) Foreign Application Priority Data
Jun. 16, 2008 (IT) MI2008A001086

(51) Int. Cl. C01B 33/037; B01J 19/00

(52) U.S. Cl. 423/349; 422/199

(57) ABSTRACT

A method and an apparatus for purification of metallurgical grade silicon by directional solidification and for obtaining silicon ingots for photovoltaic use. The method comprises a preheating step, up to a temperature that is higher than the melting point of silicon, of a quartz crucible (18) that is accommodated in a containment enclosure (19) arranged inside a chamber (4) of a furnace. The chamber (4) of the furnace is delimited by a covering structure (3) and by a footing (2), which can move with respect to each other, or vice versa, toward or away from each other along a vertical direction respectively for opening and closing the chamber (4). Heating occurs by way of heating means (10) of the electric type, which are associated with the walls of the covering structure (3). The metallurgical grade silicon obtained at the end of a carbon reduction cycle in a carbon reduction furnace, from which it exits in the molten state, is transferred in the molten state directly into the quartz crucible (18) thus preheated inside the furnace chamber, which is closed and inside which an atmosphere of inert gas at a pressure that is higher than the atmospheric pressure is generated. Transfer of the silicon in the molten state occurs through a barrier of at least one inert gas that is generated proximate to at least one opening (13) formed in the top (7b) of the covering structure (3). The method then comprises a step for directional solidification of the silicon in the molten state, by removing heat from the bottom of the quartz crucible and by means of the selective control of the heating means of the electric type and the modulation of the power delivered by them, until the silicon solidifies completely in an ingot. During the solidification step, the furnace chamber is closed and an atmosphere of an inert gas at a pressure that is higher than atmospheric pressure is maintained inside it. At the end of solidification, the quartz crucible (18) accommodated in the containment enclosure (19) and containing the ingot thus obtained is extracted from the furnace chamber, which is opened by removing the covering structure (3) from the footing (2).

### TECHNICAL FIELD

The present invention relates to a method and an apparatus for purifying metallurgical grade silicon by means of directional solidification and for obtaining silicon ingots for photovoltaic use.

### BACKGROUND ART

As is known, silicon is one of the most widely used raw materials for the production of electronic components and photovoltaic components.

Silicon is produced by reduction of compounds thereof, particularly silica (SiO₂), in an electric arc furnace in the presence of carbon-based materials. The silicon thus produced is known as “metallurgical grade silicon” and contains concentrations of metallic impurities and carbon that make it unusable for the production of electronic or photovoltaic components.

In particular, in metallurgical grade silicon the concentration of metallic impurities reaches values on the order of 3000 ppmw (parts per million by weight), which are unacceptable for the production of photovoltaic components, for which instead the tolerable metallic impurity concentration cannot exceed the total value of 0.1 ppmw; the maximum tolerable specific concentration of the individual metallic impurities depends on the nature of each one of them.

Moreover, metallurgical grade silicon contains carbon, which segregates into particles of silicon carbide (SiC), which, as is known, reduce the average life of the silicon.

Therefore, the metallurgical grade silicon must be purified of the metallic impurities and of the carbon to obtain so-called “solar” silicon, i.e., silicon suitable for producing photovoltaic components.

As is known, carbon and silicon carbide are eliminated from metallurgical grade silicon collected in the molten state in ladles, by means of annealing processes, which are performed at temperatures that are close to the melting point of silicon, and nucleation processes.

One of the known methods for eliminating metallic impurities consists instead of the directional solidification of metallurgical grade silicon, which utilizes the fact that for most metallic impurities the actual segregation coefficient, defined as the ratio between the concentration of impurity in the solid and the concentration of impurity in the liquid, is on the order of 10⁻³-10⁻⁴. With this method, the metallic impurities concentrate in the tail of the solidified ingots, which is then eliminated.

Currently known directional solidification processes for purifying metallurgical grade silicon are performed in furnaces, the internal chamber of which is kept in vacuum conditions or with an atmosphere of argon at a low pressure, i.e., below atmospheric pressure. As is known, it is in fact necessary to avoid contact of the silicon in the molten state with oxygen, both to avoid phenomena of oxidation of the silicon and to avoid the formation of boron-oxygen complexes that have a negative influence on the average life of the silicon.

Known directional solidification methods further provide for the introduction, in the corresponding furnace, of a load of metallurgical grade silicon to be purified in the solid state, its melting and its subsequent directional solidification.

These directional solidification methods for purification of metallurgical grade silicon of the known type therefore require a large energy expenditure to heat and melt the load of silicon in the solid state to be treated before its solidification. This energy expenditure is on the order of 300-400 KWh/500 kg of silicon and has a severe effect on the overall production costs of solar-grade silicon.

Another drawback of known methods consist in that the times needed for heating and melting the silicon load in the solid state to be purified prior to its solidification have a significant effect on the overall times of the purification treatment.

Another drawback of known types of directional solidification methods consist in that they are performed in furnaces the inner chamber of which is kept in vacuum conditions or in conditions of reduced pressure of argon or other inert gas, conditions which can facilitate the vaporization of silicon in the molten state.

### DISCLOSURE OF THE INVENTION

The aim of the present invention is to solve the problems described above, devising a method and an apparatus that allow to perform directional solidification for purifying metallurgical grade silicon with a reduced energy expenditure and in shorter times than known types of method.

Within the scope of this aim, another object of the present invention is to provide a method and an apparatus for directional solidification for purifying metallurgical grade silicon that allow to obtain silicon with a degree of purity that is suitable for photovoltaic use.

Another object of the present invention is to achieve said aim and object with an apparatus that has a simple structure, is relatively easy to provide in practice, is safe in use and effective in operation as well as relatively low in cost.

This aim and these objects are all achieved by the present directional solidification method for purification of metallurgical grade silicon and for obtaining silicon ingots for photovoltaic use, at the end of a carbon reduction cycle in a carbon reduction furnace, from which the metallurgical grade silicon exits in the molten state, characterized in that it comprises the following additional steps:
a preheating step, up to a temperature that is higher than the melting point of silicon, of a quartz crucible that is accommodated in a containment enclosure arranged inside a chamber of a furnace that is delimited by a covering structure and by a footing, which can move with respect to each other, or vice versa, toward or away from each other along a vertical direction respectively for opening and closing said chamber, by way of heating means of the electric type, which are associated with the walls of said covering structure;
a step for the transfer of the metallurgical grade silicon in the molten state directly into the quartz crucible thus preheated and accommodated in said containment enclosure arranged inside said chamber, which is closed, said covering structure and said footing being moved mutually closer, and inside which an atmosphere of inert gas at a pressure that is higher than the atmospheric pressure is generated, the silicon in the molten state being poured into said preheated quartz crucible through a barrier of at least one inert gas that is generated proximate to at least one opening formed in the top of said covering structure, said barrier covering at least the area of said opening;
a step for directional solidification of the silicon in the molten state, by removing heat from the bottom of said quartz crucible accommodated in said containment enclosure and by means of the selective control of said heating means of the electric type and the modulation of the power delivered by them, until the silicon solidifies completely in an ingot and during which said chamber is closed, said covering structure and said footing being moved mutually closer and said opening being blocked by a closure element of the removable type, and an atmosphere of an inert gas at a pressure that is higher than atmospheric pressure being maintained inside it;
a step for extracting the quartz crucible accommodated in said containment enclosure and containing the ingot thus obtained from the chamber, which is open, said covering structure and said footing being mutually spaced.

This aim and these objects are also achieved with an apparatus for performing said method, which is characterized in that it comprises:
a furnace, which comprises a footing and a covering structure that delimit a chamber and can move with respect to each other, or vice versa, toward and away from each other along a vertical direction respectively for opening and closing said chamber;
heating means of the electrical type, which are associated with the walls of said covering structure and are associated with control means that are suitable to activate them on command and to modulate the power delivered by them;
at least one quartz crucible accommodated in a containment enclosure that rests on said footing;
at least one opening, which is formed in the top of said covering structure and with which a closure element of the removable type is associated;
means for dispensing at least one inert gas, which are arranged proximate to said opening and are suitable to generate on command a barrier of said inert gas that covers at least the area of said opening, when said chamber is closed, said covering structure and said footing being moved mutually closer, and said closure element is removed, for transfer through it of silicon in the molten state directly into said quartz crucible;
at least one heat exchange plate, which is cooled by a circuit of a refrigerating fluid and is associated with said footing to remove heat from the bottom of said quartz crucible;
means for feeding an inert gas within said chamber when it is closed, said covering structure and said footing being moved mutually closer, in order to generate in said closed chamber an atmosphere of inert gas at a pressure that is higher than atmospheric pressure.

### BRIEF DESCRIPTION OF THE DRAWINGS

Further characteristics and advantages of the present invention will become better apparent from the detailed description of a preferred but not exclusive embodiment of a method according to the invention and of an apparatus for performing it, illustrated by way of non-limiting example in the accompanying drawings, wherein:

FIGS. 1 and 2 are schematic sectional views of an apparatus according to the invention in two different operating configurations;

FIG. 3 is a schematic sectional view of the apparatus according to the invention in the step for the transfer of the metallurgical grade silicon in the molten state into the quartz crucible;

FIG. 4 is a schematic sectional view of the apparatus according to the invention in the step for directional solidification of the silicon;

FIG. 5 is a schematic plan view of the apparatus according to the invention during the step for extraction of the quartz crucible that contains the purified silicon ingot.

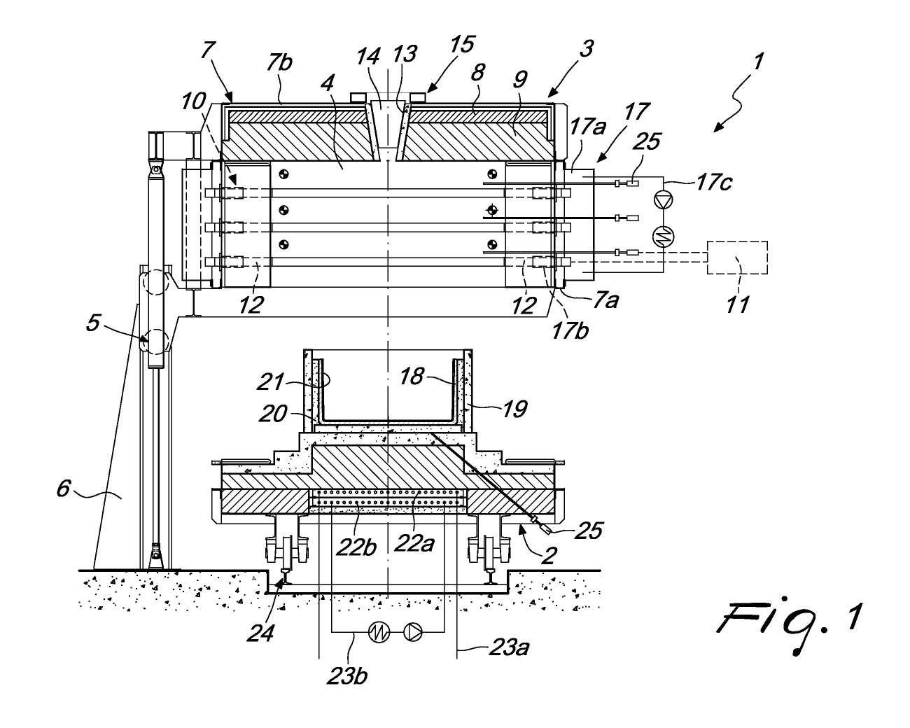

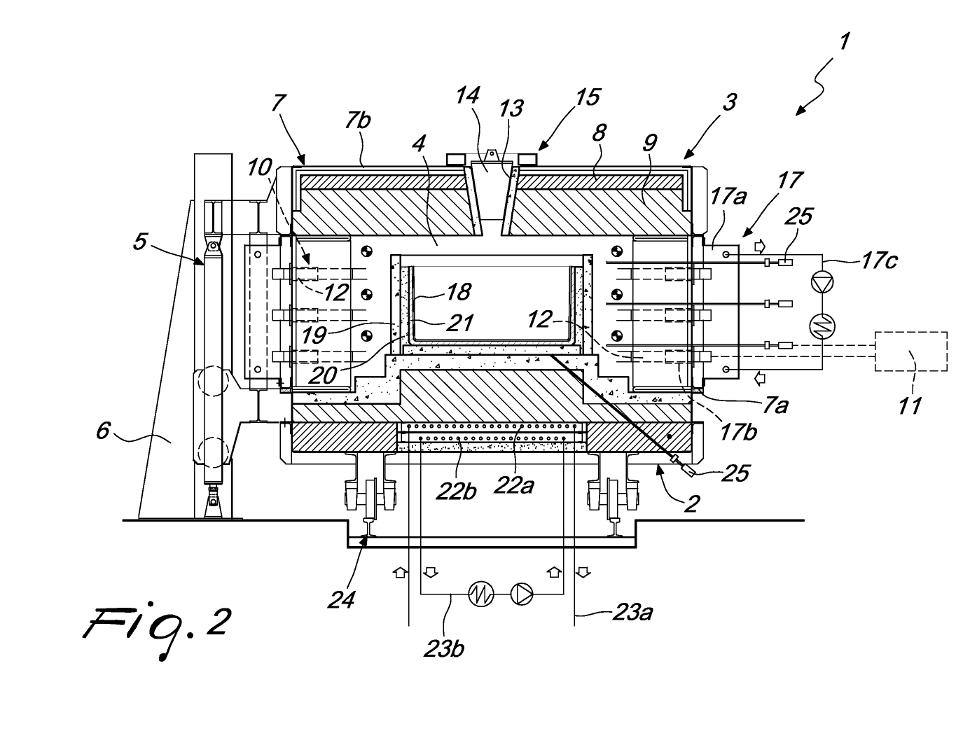

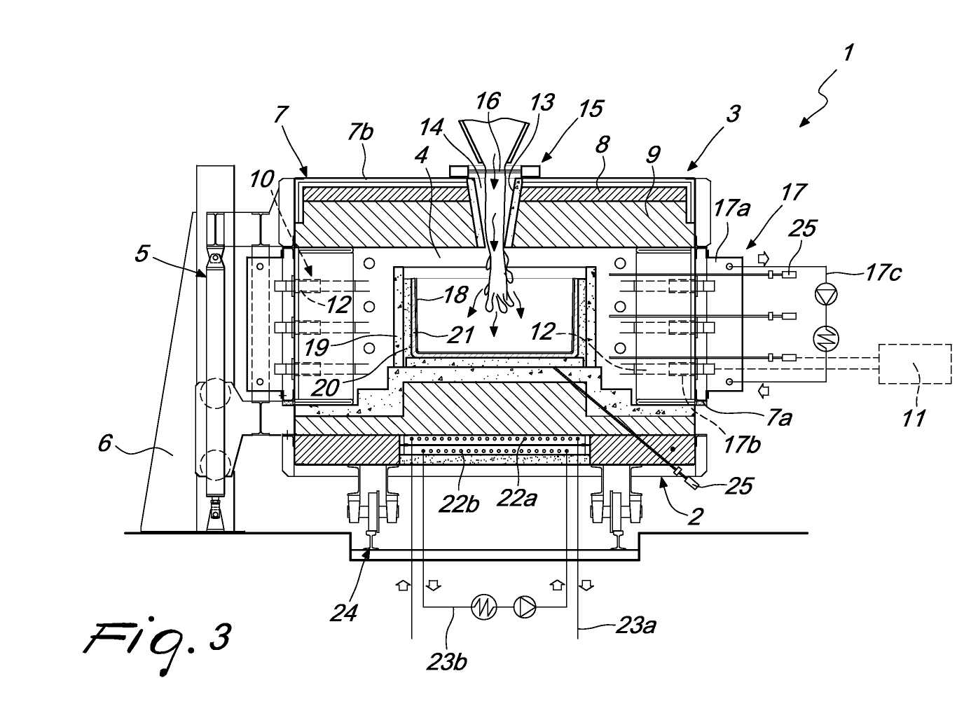

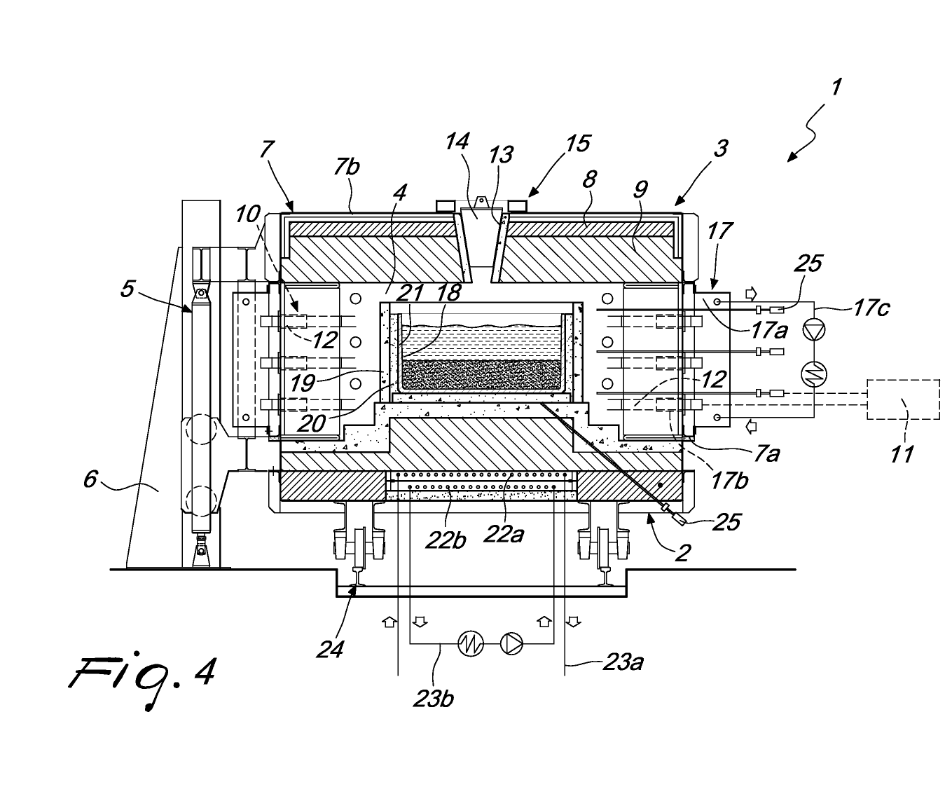

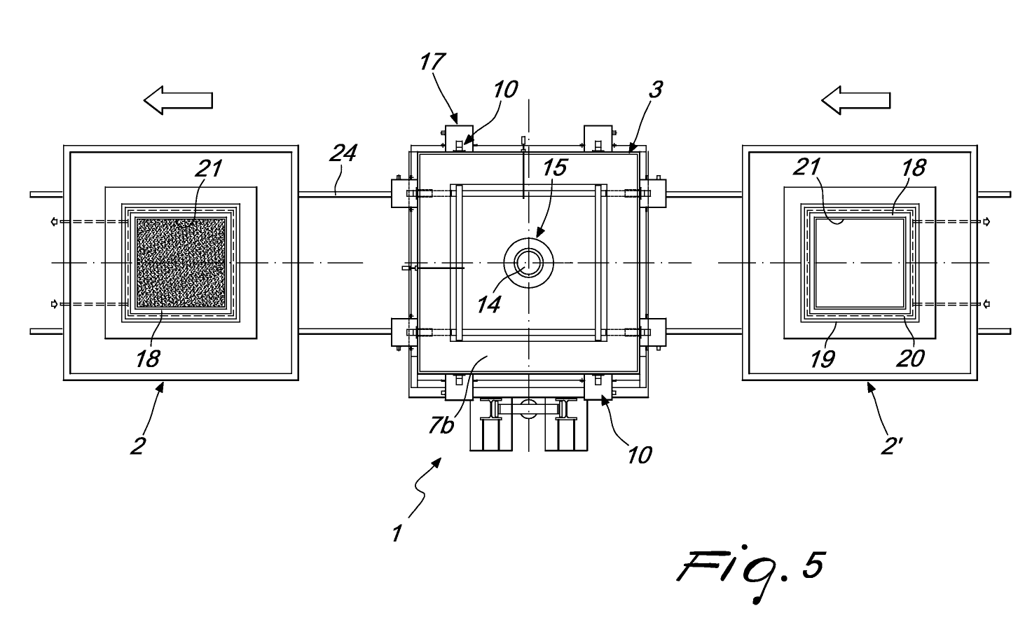

### WAYS OF CARRYING OUT THE INVENTION

With reference to the figures, the reference numeral 1 generally designates an apparatus for performing the method for purification of metallurgical grade silicon by directional solidification and for the obtainment of silicon ingots for photovoltaic use, at the end of a carbon reduction cycle of the silicon in a carbon reduction furnace from which the metallurgical grade silicon exits in the molten state.

The apparatus 1, therefore, is arranged downstream of a thermal carbon reduction furnace, which is not shown in the accompanying figures since it is not the subject of the present invention, and from which the metallurgical grade silicon exits in the molten state.

The apparatus 1 comprises a furnace, which in turn comprises a footing 2 and a covering structure 3, which delimit a chamber 4 inside which the directional solidification of the metallurgical grade silicon occurs.

The covering structure 3 and the footing 2 can move with respect to each other, or vice versa, mutually toward or away from each other along a vertical direction respectively for opening and closing the chamber 4.

In the embodiment shown in the accompanying figures, the covering structure 3 is associated with an assembly for lifting and lowering with respect to the footing 2 and comprises at least one cylinder 5 actuated by a fluid medium and of the double-acting type, in which the stem is connected to a supporting structure 6 that is fixed to the ground and the jacket is connected to the outer frame 7 of the covering structure 3.

The outer frame 7 is made of metal and forms the side walls 7a and the top 7b of the covering structure 3.

The face of the top 7b that is directed toward the inside of the covering structure 3 is lined with a layer 8 of thermal insulating material, which in turn is lined with a cementing layer 9 made of silica.

Heating means 10 of the electrical type are associated with the side walls 7a and are connected to control means 11 of the programmable type and are suitable to activate them on command and to modulate the power that they deliver.

In a preferred embodiment, the heating means 10 comprise a plurality of heating elements 12 such as resistors arranged in a vertical batteries or groups that are associated with each one of the side walls 7a. Each battery is associated with a respective electrical power supply, which is not shown.

More particularly, the heating elements 12 of each battery are constituted by silicon carbide (SiC) bars, which are arranged so as to be mutually parallel on horizontal planes at different heights with respect to each other.

At the top 7b there is at least one opening 13, which passes through the thickness of the top 7b and through which, as will become better apparent hereinafter, the metallurgical grade silicon to be purified is poured in the molten state directly into the furnace.

The opening 13 is provided with a closing element 14 of the removable type, such as for example a plug element.

Proximate to the opening 13 there are means 15 for dispensing at least one inert gas, which are suitable to generate on command a barrier 16 of inert gas that covers at least the area of the opening 13, when the chamber 4 is closed, the covering structure 3 and the footing 2 being mutually closer, and the closing element 14 is removed.

The barrier 16 allows transfer through it of metallurgical grade silicon in the molten state directly into the furnace.

The dispensing means 15 are associated with a supply of inert gas, which is not shown

In a preferred embodiment, the dispensing means 15 comprise at least one duct, which is arranged along at least one portion of the perimeter of the opening 13 and is provided with a plurality of dispensing holes or nozzles, through which at least one laminar flow of inert gas is dispensed so as to form a barrier 16 that extends parallel to the top 7b.

More particularly, the dispensing means 15 comprise a plurality of dispensing ducts, which are mutually superimposed so as to create a multilayer barrier 16.

The inert gas used to create the barrier 16 is preferably constituted by argon or by argon and air.

The barrier 16 isolates the environment inside the chamber 4, when it is closed, from the environment that lies outside it, and at the same time allows to introduce in said chamber 4 the metallurgical grade silicon in the molten state.

The apparatus 1 further comprises means 17 for feeding an inert gas into the chamber 4, when said chamber is closed, i.e., when the covering structure 3 and the footing 2 are mutually closer and further the opening 13 is blocked by the closure element 14, in order to generate therein an atmosphere of inert gas at a pressure that is higher than the atmospheric pressure.

The inert gas is preferably argon and the pressure at which it is kept inside the chamber 4 is on the order of 1.1 bars.

The means 17 for feeding the inert gas comprise, for each battery of heating elements 12, a manifold 17a, from which a plurality of ducts 17b for introducing inert gas branch out which are connected to the chamber 4, each duct accommodating the end for connection to an electric power supply of at least one respective heating element 12. The supplied inert gas thus cools the end for connection of the heating elements 12 before it is introduced in the chamber 4.

There is also a circuit 17c for recycling and cooling the inert gas in order to reduce its consumption.

A quartz crucible 18 rests on the upper surface of the footing 2 and is accommodated in a containment enclosure 19 that prevents the collapse of the quartz crucible 18 when the silicon in the molten state is poured inside it.

An interspace is formed between the quartz crucible 18 and the containment enclosure 19 and is filled with a layer 20 of ceramic oxide powders selected from the group comprising: quartz, MgO, Al₂O₃ and the like.

The containment enclosure 19 is made of ceramic material, typically based on alumina, silicon-aluminates and silicon carbide.

The internal surface of the quartz crucible 18 is covered with lining material 21, which is suitable to prevent the silicon in the molten state from wetting the inner walls of said quartz crucible.

Preferably, this lining material 21 comprises silicon nitride or the like and the lining layer that covers the inner surface of the bottom of the quartz crucible 18 is thicker than the lining layer that covers the inner surface of the walls of the quartz crucible 18 with a ratio comprised between 1.5 and 3.

At least one heat exchange plate 22 is associated with the footing 2 and is cooled by a circuit 23 of a coolant fluid for removing heat from the bottom of the quartz crucible 18.

In the illustrated embodiment there are two heat exchange plates 22a and 22b, which are mutually superimposed and parallel to the resting surface of the footing 2.

The upper plate 22a is associated with a circuit 23a of a first coolant fluid, for example air, argon, helium or the like, and the lower plate 22b is associated with a circuit 23b of a second coolant fluid, for example water; the upper plate 22a has a lower heat exchange coefficient than the lower plate 22b.

The upper plate 22a and the lower plate 22b can be activated selectively on command during the step for directional solidification of the silicon and/or during the step for cooling the solidified silicon ingot.

The upper heat exchange plate 22a is made of metal, such as stainless steel, copper or the like, or of porous ceramic material.

The lower heat exchange plate 22b is made exclusively of metal, such as stainless steel, copper or the like.

The footing 2 is further supported so that it can move along sliding guides 24, which run horizontally. When the covering structure 3 is in the raised configuration, the footing 2 can be moved closer or further away from the area that lies below such covering structure 3.

The apparatus 1 is further completed by a plurality of temperature sensors, such as thermocouples 25 connected to the control means 11.

Operation of the apparatus 1 for performing the method for purification of metallurgical grade silicon by directional solidification and for obtainment of silicon ingots for photovoltaic use, at the end of a carbon reduction cycle in a carbon reduction furnace from which the metallurgical grade silicon exits in the molten state, according to the invention, is as follows.

At the beginning of the process, the covering structure 3 is kept in a raised configuration with respect to the footing 2, on which a containment enclosure 19 rests inside which an empty quartz crucible 18 is accommodated.

The inner surface of the quartz crucible 18 is covered with the lining material 21.

The covering structure 3, whose opening 13 is blocked by the closure element 14, is lowered progressively toward the footing 2 that lies below it until the chamber 4 is closed.

The quartz crucible 18 is subjected to a preheating step, up to a temperature that is higher than the melting point of silicon, inside the chamber 4, thus closed, by means of the selective activation and modulation of the power delivered by the heating elements 12.

During the preheating step, sintering of the lining material 21 applied previously in the suspended state on the inner surface of the quartz crucible 18 is performed or at least completed.

For this purpose, the preheating step comprises in succession:
a first stage, in which the quartz crucible 18 is gradually heated to a temperature comprised between 550° C. and 650° C., preferably 600° C.;
a second stage, in which the quartz crucible 18, arranged inside the closed chamber 4, is heated to a temperature of 1000° C. and is kept at that temperature for a time on the order of 1 h,
a third stage for heating up to a temperature comprised between 1450° C. and 1550° C., preferably equal to 1500° C.

The preheating step has a total duration that can vary between 3 h and 5 h.

At the end of the preheating step, inside the chamber 4, which is kept closed, an atmosphere of inert gas at a pressure that is higher than atmospheric pressure and on the order 100 mbar is created by means of the supply means 17.

It should be noted that the inert gas that is fed into the chamber 4 through the ducts 17b cools the connecting ends of the heating elements 12.

Subsequently, the metallurgical grade silicon in the molten state obtained by means of a carbon reduction process inside an appropriately provided furnace is transferred, still in the molten state, directly into the preheated quartz crucible 18 which is inside the chamber 4.

Such transfer step occurs by removing the closure element 14 from the opening 13 and by activating the dispensing means 15 so as to create, proximate to the opening 13, a harrier 16 of inert gas which on the one hand allows to isolate the atmosphere created inside the chamber 4 from the environment that lies outside it, avoiding in particular the inflow of air of other contaminants into the chamber 4 and on the other hand allows passage through it of the silicon in the molten state.

The metallurgical grade silicon to be purified is then poured into the preheated quartz crucible 18, which is accommodated in the chamber 4 directly in the molten state.

At the end of the transfer, the opening 13 is blocked by the closure element 14 and the molten silicon load poured into the quartz crucible 18 is kept at a temperature comprised between 1430° C. and 1450° C., preferably proximate to 1450° C., for a time on the order of 2 h to segregate the supersaturated carbon.

At the end of this maintenance and segregation step, the step for directional solidification of the silicon load poured into the quartz crucible 18 begins.

The step of directional solidification occurs by removing heat from the bottom of the quartz crucible 18, accommodated in the containment enclosure 19, through the heat exchange plates 22a and 22b that are associated with the footing 2 and by means of the selective control of the heating elements 12 and the modulation of the power that they deliver, until the silicon solidifies completely in an ingot.

During this step of solidification inside the chamber 4, an atmosphere of inert gas of the pressure that is higher than atmospheric pressure is maintained.

The solidification step begins with the deactivation of the heating elements 12 arranged, in each individual battery, at a lower level and by means of the activation of the upper heat exchange plate 22a, which is cooled by gas (air, helium, argon), so as to remove the heat gradually in order to perform the process in conditions that are close to the equilibrium conditions and thus ensure the best purification characteristics.

Subsequently, the power levels delivered by the heating elements 12 at progressively higher levels are deactivated and/or modulated by following temperature curves inside the chamber 4 and the silicon load, which are preset and monitor by an appropriate control and command unit.

In particular, the temperature of the solidified silicon is kept a few degrees Celsius below the melting point of silicon until the entire load has solidified completely.

Directional solidification is performed at a rate that does not exceed 4 cm/h, a rate that ensures correct segregation of impurities, and lasts in total between 6 and 10 hours.

At the end of the directional solidification step, a silicon ingot has formed inside the crucible 18; in said ingot, in which the metallic impurities are concentrated in the so-called tail, which is subsequently eliminated by cutting.

Prior to the step for extraction of the ingot thus obtained from the chamber 4, one proceeds with a step for cooling the ingot to a temperature comprised between 650° C. and 550° C., preferably equal to 600° C.

This cooling step occurs inside the closed chamber 4, inside which an atmosphere of inert gas at a pressure that is higher than atmospheric pressure is maintained.

This cooling step occurs by deactivating the heating elements 12 and by activating, in addition to the upper heat exchange plate 22a, also the water-cooled lower heat exchange plate 22b.

Once a temperature proximate to 600° C. has been reached, the chamber 4 is opened by lifting the covering structure 3 with respect to the footing 2.

The footing 2 is moved away along the sliding guides 24 and is replaced with another footing 2′ for the beginning of a new cycle.

It should be noted that at the end of a production cycle inside the covering structure 3 there is a temperature on the order of 400-500° C., heat which is utilized for the preheating step of the subsequent cycle.

In practice it has been found that the method and the apparatus for performing it achieve the intended aim and objects, since they allow to perform purification of metallurgical grade silicon by directional solidification and to obtain silicon ingots for photovoltaic use with a lower energy expenditure and in shorter times than known methods.

The method according to the invention, in fact, thanks to the introduction of the metallurgical grade silicon in the molten state, obtained at the end of the thermal carbon reduction cycle, directly inside the directional solidification furnace, allows to eliminate both the energy costs and the heating and melting times of the silicon load which, in known methods, is introduced in the directional solidification furnaces in the solid state.

A further reduction in the times and energy expenditure that is obtained with the method and the apparatus for performing it according to the invention derives from the fact that the sintering of the material for lining the surface inside the crucible is performed simultaneously with the preheating of said crucible in the directional solidification furnace, and in that the beginning of a new production cycle occurs when the unidirectional solidification furnace, or rather the covering structure, is still warm.

The invention thus conceived is susceptible of numerous modifications and variations, all of which are within the scope of the appended claims.

All the details may further be replaced with other technically equivalent ones.

In practice, the materials used, as well as the shapes and dimensions, may be any according to requirements without thereby abandoning the scope of the protection of the appended claims.

The disclosures in Italian Patent Application no. MI2008A001086, from which this application claims priority, are incorporated herein by reference,

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1-21. (canceled)

22. A method for purification of metallurgical grade silicon by directional solidification and for obtaining silicon ingots for photovoltaic use, at the end of a carbon reduction cycle in a carbon reduction furnace, from which the metallurgical grade silicon exits in the molten state, comprising the following additional steps:
a preheating step, up to a temperature that is higher than the melting point of silicon, of a quartz crucible that is accommodated in a containment enclosure arranged inside a chamber of a furnace that is delimited by a covering structure and by a footing, which can move with respect to each other, or vice versa, toward or away from each other along a vertical direction respectively for opening and closing said chamber, by way of heating means of the electric type, which are associated with the walls of said covering structure;
a step for the transfer of the metallurgical grade silicon in the molten state directly into the quartz crucible thus preheated and accommodated in said containment enclosure arranged inside said chamber, which is closed, said covering structure and said footing being moved mutually closer, and inside which an atmosphere of inert gas at a pressure that is higher than the atmospheric pressure is generated, the silicon in the molten state being poured into said preheated quartz crucible through a barrier of at least one inert gas that is generated proximate to at least one opening formed in the top of said covering structure, said barrier covering at least the area of said opening;
a step for directional solidification of the silicon in the molten state, by removing heat from the bottom of said quartz crucible accommodated in said containment enclosure and by means of the selective control of said heating means of the electric type and the modulation of the power delivered by them, until the silicon solidifies completely in an ingot and during which said chamber is closed, said covering structure and said footing being moved mutually closer and said opening being blocked by a closure element of the removable type, and an atmosphere of an inert gas at a pressure that is higher than atmospheric pressure being maintained inside it;
a step for extracting the quartz crucible accommodated in said containment enclosure and containing the ingot thus obtained from the chamber, which is open, said covering structure and said footing being mutually spaced.

23. The method according to claim 22, further comprising, after said transfer step and before said solidification step, a step for keeping the molten silicon at a temperature comprised between 1430° C. and 1450° C. for a time on the order of 2 h to segregate the supersaturated carbon.

24. The method according to claim 22, further comprising, after said solidification step and before said extraction step, a step for cooling said ingot inside said closed chamber to a temperature comprised between 650° C. and 550° C.

25. The method according to claim 22, further comprising, before said preheating step, a step for application on the inner surface of said quartz crucible of a lining material that is suitable to prevent the silicon in the molten state from wetting the inner walls of said quartz crucible.

26. The method according to claim 25, wherein said lining material comprises a suspension of silicon nitride, the sintering of which occurs or is at least completed during said preheating step.

27. The method according to claim 26, wherein said application step comprises applying to the inner surface of the bottom of said quartz crucible a layer of said silicon nitride suspension whose thickness is greater than the layer applied to the inner surface of the walls of said quartz crucible with a ratio comprised between 1.5 and 3.

28. The method according to claim 22, wherein said preheating step comprises in succession: a first stage, in which said quartz crucible is gradually heated to a temperature comprised between 550° C. and 650° C.; a second stage, in which said quartz crucible is heated to a temperature of 1000° C. and is kept at said temperature for a time on the order of 1 h; and a third stage for heating up to a temperature comprised between 1450° C. and 1550° C.

29. The method according to claim 28, wherein said first stage occurs by moving said covering structure and said footing gradually closer, said footing supporting said quartz crucible accommodated in said containment enclosure, until said chamber is closed, and controlling selectively said heating means of the electric type and modulating the power that they deliver.

30. The method according to claim 22, wherein during said solidification step the removal of heat from the bottom of said quartz crucible accommodated in said containment enclosure occurs by means of at least one heat exchange plate that is cooled by a circuit of a refrigerating fluid and is associated with said footing, said containment enclosure resting on said footing.

31. The method according to claim 24, wherein said cooling step occurs within said closed chamber, in which said atmosphere of inert gas is maintained at a pressure that is higher than the atmospheric pressure by deactivation of said heating means of the electric type and extraction of the heat from the bottom of said quartz crucible accommodated in said containment enclosure.

32. The method according to claim 22, wherein said extraction step occurs by moving away from said covering structure said footing, on which said quartz crucible accommodated in said containment enclosure and containing said ingot rests, and by replacing it with another footing to start a new cycle.

33. An apparatus for performing the method according to claim 22, comprising:
a furnace which comprises a footing and a covering structure, which delimit a chamber and can move with respect to each other or vice versa toward or away from each other along a vertical direction respectively for opening and closing said chamber;
heating means of the electrical type, which are associated with the walls of said covering structure and are associated with control means suitable to activate them on command and to modulate the power delivered by them;
at least one quartz crucible accommodated in a containment enclosure that rests on said footing;
at least one opening, which is formed in the top of said covering structure and with which a closure element of the removable type is associated;
means for dispensing at least one inert gas, which are arranged proximate to said opening and are suitable to generate on command a barrier of said inert gas that covers at least the area of said opening, when said chamber is closed, said covering structure and said footing being moved mutually closer, and said closure element is removed, for the transfer through it of silicon in the molten state directly in said quartz crucible;
at least one heat exchange plate, which is cooled by a circuit of a refrigerating fluid and is associated with said footing for the removal of heat from the bottom of said quartz crucible;
means for feeding an inert gas inside said chamber when closed, said covering structure and said footing being moved mutually closer, in order to generate in said closed chamber an atmosphere of inert gas at a pressure that is higher than the atmospheric pressure.

34. The apparatus according to claim 33, wherein said heating means of the electrical type comprise a plurality of heating elements such as resistors arranged in vertical batteries.

35. The apparatus according to claim 34, wherein said means for feeding an inert gas comprise, for each one of said batteries, a manifold from which a plurality of ducts for introducing said inert gas branches, said ducts being connected to said chamber, each one accommodating the end for connection to an electric power supply of at least one of said heating elements, the inert gas fed by said supply means cooling said connection ends before being introduced in said chamber.

36. The apparatus according to claim 34, wherein said heating elements are made of silicon carbide (SiC).

37. The apparatus according to claim 33, wherein said containment enclosure is made of ceramic material.

38. The apparatus according to claim 33, wherein between said quartz crucible and said containment enclosure there is an interspace filled with powders of ceramic oxides selected from the group comprising: quartz, MgO, Al₂O₃, and the like.

39. The apparatus according to claim 33, wherein the inner surface of said quartz crucible is covered with lining material suitable to prevent the silicon in the molten state from wetting the inner walls of said quartz crucible.

40. The apparatus according to claim 39, wherein said lining material comprises silicon nitride or the like, the layer of said lining material that covers the inner surface of the bottom of said quartz crucible being thicker than the layer of said lining material that covers the inner surface of the walls of said quartz crucible with a ratio comprised between 1.5 and 3.

41. The apparatus according to claim 33, further comprising at least two of said heat exchange plates, each one cooled by a respective circuit of a refrigerating fluid, which are mutually superimposed and can be activated selectively on command and of which the upper plate has a lower heat exchange coefficient than the lower plate.

42. The apparatus according to claim 33, further comprising a plurality of said footings which can be mutually replaced and associated with said covering structure.
